(19) United States
(12) Patent Application Publication
(10) Pub. No.: US 2026/0320192 A1
(43) Pub. Date: Oct. 15, 2026

(54) ENHANCING SYSTEM-RELATED GRAPH NEURAL NETWORKS

(71) Applicant: Dell Products L.P., Round Rock, TX (US)

(72) Inventors: Shashank Kapoor, Agra (IN); Kailash Talreja, Mumbai (IN); Saurabh Jha, Leander, TX (US)

(21) Appl. No.: 19/177,715

(22) Filed: Apr. 14, 2025

(51) Int. Cl. G06F 21/57

(52) U.S. Cl. CPC G06F 21/577; G06F 2221/033

(57) ABSTRACT

Methods, apparatus, and processor-readable storage media for enhancing system-related graph neural networks (GNNs) are provided herein. An example computer-implemented method includes decoupling, using a GNN model, a latent space of an input graph structure into a first latent space and a second latent space; generating a synthetic version of the input graph structure by implementing designated perturbations to the first and second latent spaces; detecting one or more anomalies associated with the synthetic version based on latent space deviations between the input graph structure and the synthetic version; performing a determination that the one or more anomalies are caused by the designated perturbations to the first latent space and/or to the second latent space; and performing one or more automated actions, based on the performing of the determination, in connection with modifying the input graph structure and/or the GNN model.

### BACKGROUND

Graph structures are often used to model relationships in applications such as social networks, Internet of Things (IOT) systems, cybersecurity frameworks, etc. However, conventional approaches for utilizing and/or managing graph structures are prone to adversarial attacks related to modifications to graph data, which can result in the misclassification of information and/or other security issues. Additionally, such conventional approaches also typically rely on reactive measures that attempt to respond to attacks only after the attacks occur.

### SUMMARY

Illustrative embodiments of the disclosure provide techniques for enhancing system-related graph neural networks (GNNs).

An example computer-implemented method includes decoupling, using at least one GNN model, a latent space of at least one input graph structure into at least a first latent space related to topology and one or more relationships in the at least one input graph structure, and at least a second latent space related to one or more localized changes in the at least one input graph structure. The method also includes generating at least one synthetic version of the at least one input graph structure by implementing one or more designated perturbations to the at least a first latent space and implementing one or more designated perturbations to the at least a second latent space, and detecting one or more anomalies associated with the at least one synthetic version of the at least one input graph structure based at least in part on computing one or more latent space deviations between the at least one input graph structure and the at least one synthetic version. Additionally, the method includes performing a determination that the one or more anomalies are caused by at least one of the one or more designated perturbations to the at least a first latent space and the one or more designated perturbations to the at least a second latent space. Further, the method also includes performing one or more automated actions, based at least in part on the performing of the determination, in connection with modifying at least one of the at least one input graph structure and the at least one GNN model.

Illustrative embodiments can provide significant advantages relative to conventional approaches for utilizing and/or managing graph structures. For example, problems associated with misclassification of information arising from adversarial attacks related to modifications to graph data are overcome in one or more embodiments through modifying GNNs and/or corresponding graph structures in connection with decoupling latent spaces of the graph structures and detecting anomalies therein.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for enhancing system-related GNNs in an illustrative embodiment.

FIG. 2 shows an example workflow in an illustrative embodiment.

FIG. 3 shows an example latent space decoupling workflow in an illustrative embodiment.

FIG. 4 shows an example adversarial activity detection and classification workflow in an illustrative embodiment.

FIG. 5 shows an example defense mechanism adaptation workflow in an illustrative embodiment.

FIG. 6 is a flow diagram of a process for enhancing system-related GNNs in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

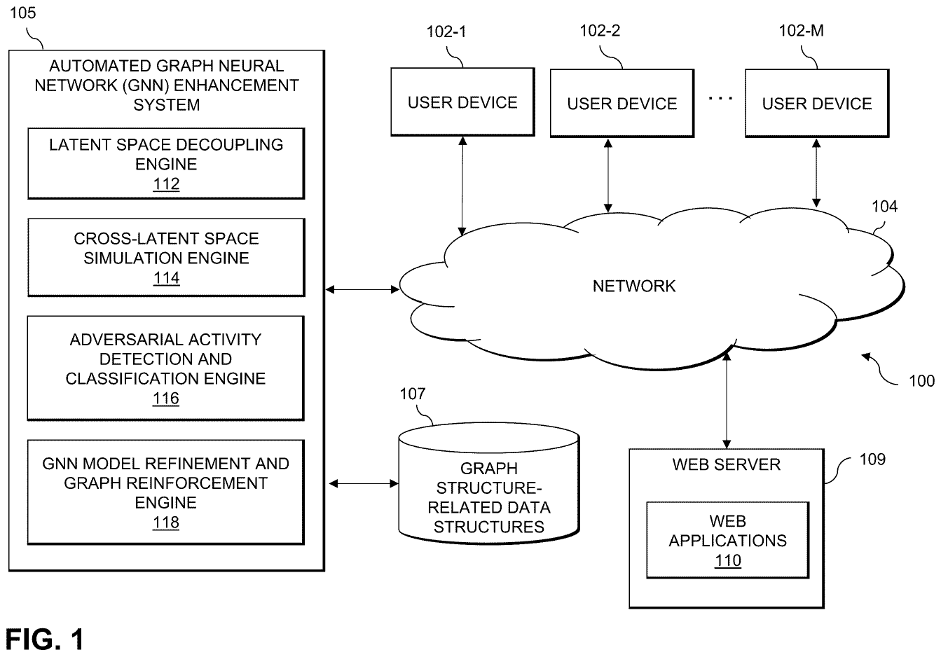

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated GNN enhancement system 105 and web server 109, upon which one or more web applications 110 execute (e.g., one or more social network applications, one or more IOT-related applications, one or more cybersecurity-related applications, etc.).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated GNN enhancement system 105 can have one or more graph structure-related data structures 107 configured to store data pertaining to one or more graph structures including node information, edge information, graph modification information, adversarial activity information, GNN-related information, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The graph structure-related data structures 107 in the present embodiment are implemented using one or more storage systems associated with the automated GNN enhancement system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated GNN enhancement system 105 are one or more input-output devices, which illustratively comprise keyboards, displays or other types of input-output devices in any combination. Such input-output devices can be used, for example, to support one or more user interfaces to the automated GNN enhancement system 105, as well as to support communication between the automated GNN enhancement system 105 and other related systems and devices not explicitly shown.

Additionally, the automated GNN enhancement system 105 in the FIG. 1 embodiment is assumed to be implemented using at least one processing device. Each such processing device generally comprises at least one processor and an associated memory, and implements one or more functional modules for controlling certain features of the automated GNN enhancement system 105.

More particularly, the automated GNN enhancement system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated GNN enhancement system 105 to communicate over the network 104 with the user devices 102, and illustratively comprises one or more conventional transceivers.

The automated GNN enhancement system 105 further comprises a latent space decoupling engine 112, a cross-latent space simulation engine 114, an adversarial activity detection classification engine 116, and a GNN model refinement and graph reinforcement engine 118.

As further detailed herein, in at least one embodiment, latent space decoupling engine 112 is configured and/or implemented to decouple the latent representation of a graph into at least two distinct spaces including, for example, a structural latent space which captures the global topology and relationships in the graph, and a dynamic latent space, which focuses on one or more localized, time-sensitive changes associated with the graph. This separation enables precise anomaly detection by isolating structural and dynamic perturbations. As used herein, latent space represents condensed feature representation of given knowledge. By way of example, in one or more embodiments, latent space encodes global graph properties such as topology and clustering information, while dynamic latent space encodes localized, time-sensitive changes such as variational in signal strength.

Also, in at least one embodiment, cross-latent space simulation engine 114 applies one or more controlled perturbations to both the structural latent space and the dynamic latent space to simulate one or more adversarial scenarios. The synthetic graphs reconstructed from these perturbed latent spaces can be analyzed to identify one or more vulnerabilities and test the corresponding system's defenses before deployment.

Additionally, in one or more embodiments, adversarial activity detection and classification engine 116 analyzes deviations, identified at least in part using the reconstructed synthetic graphs, in the structural latent space and the dynamic latent space, identifying anomalies based at least in part on the deviations, and determining whether such anomalies are caused by structural and/or dynamic perturbations.

Further, in at least one embodiment, GNN model refinement and graph reinforcement engine 118 dynamically refines the GNN model and reinforces one or more vulnerable components of the corresponding graph based at least in part on insights derived from the simulations and detection of any anomalies. Such refinement and reinforcement facilitates continuous improvement in resilience from adversarial attacks and/or other security risks associated with the graph. In one or more embodiments, at least one attention mechanism is used to execute one or more refinements in the GNN. For example, if there is a sparse connection to a node, then such an embodiment includes refining the node, and if there is a dense connection to a node, then such an embodiment includes applying high attention to the node and filtering out the node.

It is to be appreciated that this particular arrangement of elements 112, 114, 116 and 118 illustrated in the automated GNN enhancement system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for enhancing system-related GNNs involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated GNN enhancement system 105, graph structure-related data structures 107, and web server 109 can be on and/or part of the same processing platform.

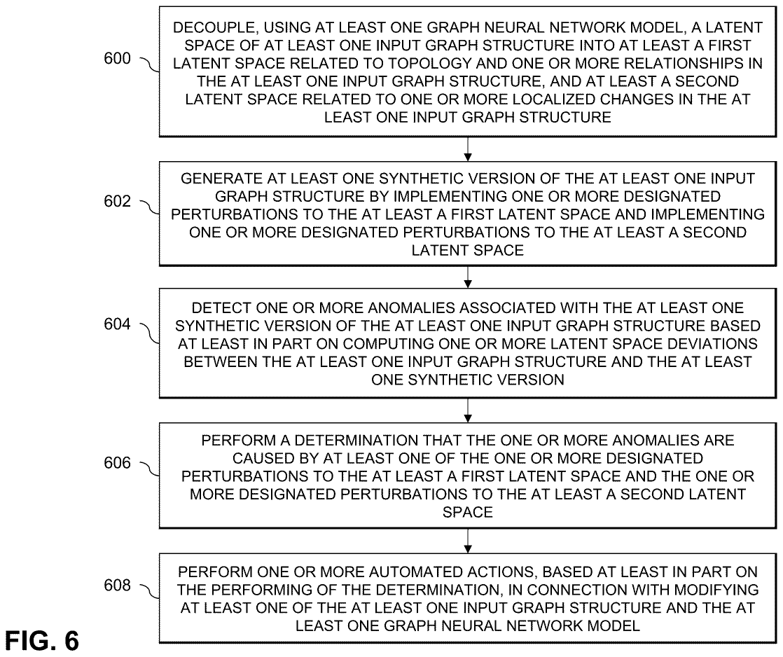

An example process utilizing elements 112, 114, 116 and 118 of an example automated GNN enhancement system 105 in computer network 100 will be described in more detail with reference to the flow diagram of FIG. 6.

Accordingly, at least one embodiment includes enhancing system-related GNN models. For example, such an embodiment can include generating and/or implementing an adversarial-resilient GNN framework with latent decoupling and dynamic simulation for secure systems (e.g., IOT systems).

As noted and further detailed herein, a graph commonly includes nodes and edges, and in one or more embodiments, such nodes and/or edges can represent various elements such as, for example, devices in a network, relationships in social graphs, etc. Also, GNNs can be configured and/or trained to process graph data by extracting features that capture local and/or global patterns, and based at least in part on such patterns, one or more predictions can be determined and/or generated. However, in some instances, adversarial attacks can exploit weaknesses in these features by, e.g., modifying one or more nodes and/or edges to degrade GNN performance. Accordingly, one or more embodiments include generating and/or implementing a framework to proactively enhance the resilience of GNNs against adversarial threats.

Such an embodiment includes decoupling the latent representation of graphs into multiple spaces: at least one space capturing one or more global structural properties and at least one space focusing on one or more localized, time-sensitive variations. By way of example, signal strength at one or more designated time intervals can be localized as time-sensitive variations. Also, consider that a node can provide two values at every timestamp, one being a sensor reading and another being signal strength, and such values are localized and time sensitive readings are received and processed. By simulating one or more adversarial scenarios through one or more controlled perturbations in these spaces, such an embodiment includes reconstructing one or more synthetic graphs to proactively test and refine one or more defense mechanisms. Accordingly, such an embodiment further includes identifying one or more vulnerabilities, evaluating one or more resilience metrics, and adapting one or more defenses dynamically, facilitating robustness across diverse applications (e.g., IOT networks, social networks, cybersecurity systems, autonomous systems, etc.).

One or more embodiments can include addressing challenges such as, for example, challenges in the deployment of GNNs for next-generation Internet of Things (NG-IOT) systems. More particularly, such an embodiment can include improving GNN susceptibility to adversarial attacks, enhancing adaptability, improving representation of graph features, and implementing dynamic simulation and evaluation of adversarial scenarios.

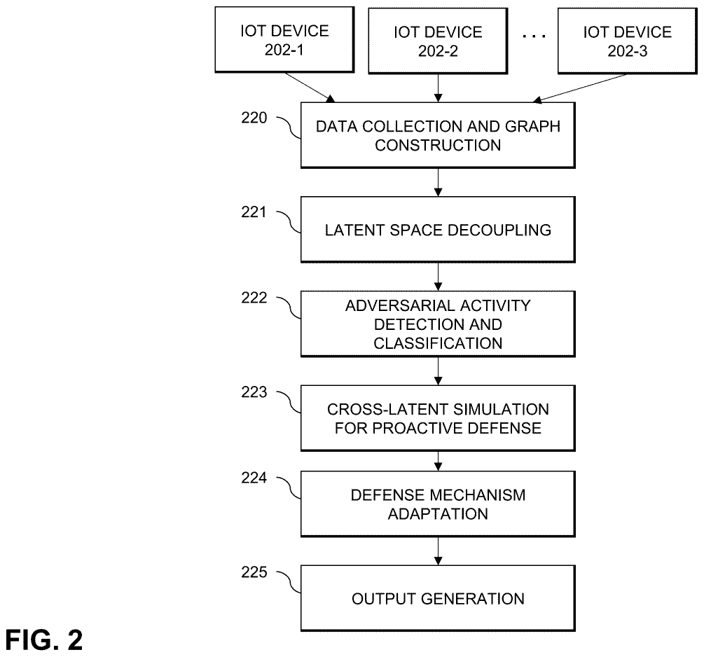

FIG. 2 shows an example workflow in an illustrative embodiment. By way of illustration, step 220 includes data collection (from IOT devices 202-1, 202-2 and/or 202-3) and graph construction, step 221 includes latent space decoupling, and step 222 includes adversarial activity detection and classification. Further, step 223 includes cross-latent simulation for proactive defense, step 224 includes defense mechanism adaptation, and step 225 includes output generation.

In at least one embodiment, data collection and graph construction in step 220 can include gathering and/or obtaining raw data from IOT devices (e.g., IOT devices 202-1, 202-2 and/or 202-3 within at least one IOT network) and constructing at least one graph representation that can be processed by one or more GNNs. By way merely of illustration, the collected data can include one or more node features and one or more edge features. Node features can include attributes of individual devices, such as, for example, device type (e.g., temperature sensor, camera, gateway, etc.), sensor readings (e.g., temperature=25.3 degrees Celsius, frame rate=30 frames per second (fps), etc.), location (e.g., global positioning system (GPS) coordinates or (37.7749, −122.4194)), signal strength (e.g., −67 decibel milliwatts (dBm)), and communication latency (e.g., 20 milliseconds (ms)). Edge features can include attributes of connections between devices, such as, for example, graph topology (e.g., information about how devices are connected, represented using adjacency matrices or lists). In one or more embodiments, at least a portion of the collected data is used to build a graph G=(V, E), wherein V represents the set of nodes, each representing a device with one or more associated features, and E represents the set of edges, each representing an interaction and/or communication link (between nodes) with one or more associated attributes. By way merely of example, consider an IOT network with following data:
Node-1: Type=Temperature Sensor, Reading=25.3 degrees Celsius, Location=(37.7749, −122.4194);
Node-2: Type=Camera, Frame Rate=30 fps, Location=(37.7750, −122.4195).
Edge (1, 2): {Signal Strength:=−67 dBm, Latency=20 ms}.

At least one graph based on the above-noted data is then created and stored in a structured format.

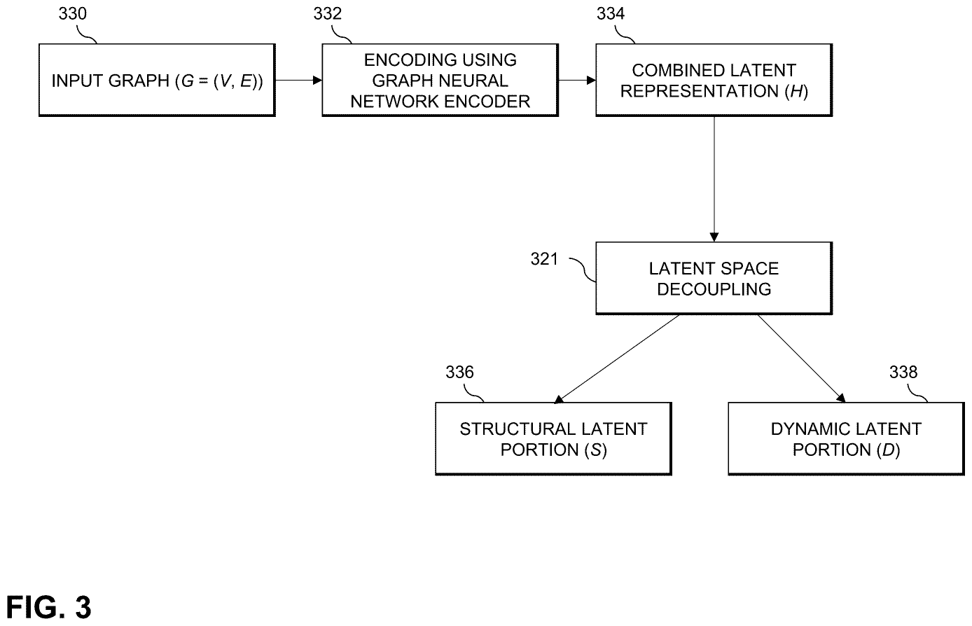

FIG. 3 shows an example latent space decoupling workflow in an illustrative embodiment. By way of illustration, FIG. 3 depicts a workflow for latent space decoupling (such as depicted in step 221 in FIG. 2), which involves transforming the constructed input graph (G=(V,E)) 330 into two distinct latent spaces: a structural latent portion (S) 336, which encodes global topology and connectivity of the input graph 330, and a dynamic latent portion (D) 338, which encodes localized, time-sensitive variations represented in the input graph 330. These latent spaces can be used to analyze the global structure and one or more localized interactions of the graph separately, facilitating detection of specific and/or different types of anomalies. In the example embodiment depicted in FIG. 3, the latent space decoupling process includes graph encoding in step 332, wherein at least one GNN processes the input graph 330 and generates a combined latent representation 334 indicated as follows: H=GNN(G), wherein H captures both global and local graph features. Latent space decoupling is then carried out on the combined latent representation 334 in step 321, resulting in structural latent portion (S) 336 and dynamic latent portion (D) 338.

As noted, at least one embodiment includes generating at least one structural latent portion (S), which encodes global graph properties (e.g., topology, clustering, etc.), and at least one dynamic latent portion (D), which encodes localized, time-sensitive changes (e.g., variations in signal strength). This separation uses one or more specific mechanisms such as, for example, global pooling and one or more attention mechanisms. With respect to global pooling, to create S, one or more embodiments include aggregating one or more features across the entire graph. With respect to one or more attention mechanisms, such an embodiment includes refining D by focusing on one or more fine-grained interactions.

For example, continuing with the above-noted example, the latent spaces can be represented as follows: S=[0.80, 0.75, 0.90], which captures the overall topology, including clustered interactions between sensors and cameras; and D=[0.15, 0.20, 0.25], which captures variations in signal strength and latency between specific nodes. Separating S and D enables targeted analysis of anomalies (structural versus dynamic anomalies), enhanced precision and interpretability of detection results, and improved adaptability to evolving graph changes.

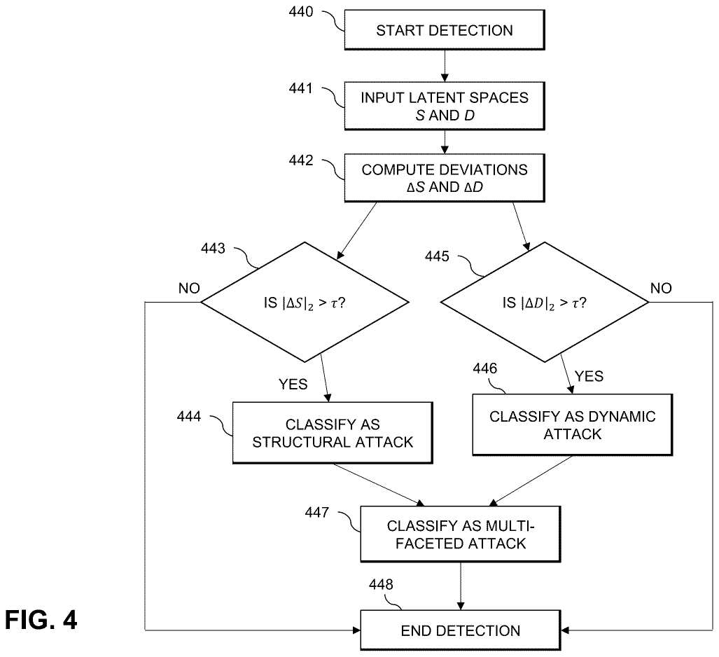

FIG. 4 shows an example adversarial activity detection and classification workflow in an illustrative embodiment. By way of illustration, FIG. 4 depicts detecting and classifying adversarial activities by analyzing deviations in one or more generated latent spaces, identifying anomalies based at least in part on the deviations, and determining whether such anomalies are caused by structural and/or dynamic perturbations.

More particularly, step 440 includes starting the detection process, step 441 includes inputting latent spaces S and D, and step 442 includes computing deviations, ΔS and ΔD. Computing the deviations can include comparing the input latent spaces S and D with their respective baselines to calculate deviations, wherein deviations indicate potential anomalies). Such deviation computations can be carried out using Equation (1) and Equation (2) as follows:

ΔS=S−S_{baseline} (1)

ΔD=D−D_{baseline} (2)

Additionally, anomaly detection can include measuring the magnitude of the deviations using at least one distance metric (e.g., Euclidean distance). Such magnitude determinations (also referred to as deviation scores) can be carried out, for example, using Equation (3) and Equation (4) as follows:

Deviation Score (structural)=|ΔS|₂ (3)

Deviation Score (dynamic)=|ΔD|₂ (4)

If, in one or more embodiments, the deviation score exceeds a designated threshold t, then the corresponding deviation is flagged as an anomaly.

Further, anomaly classification can include categorizing or classifying anomalies as structural or dynamic attacks. Referring again to FIG. 4, such a classification can be carried out in step 443 by determining if |ΔS|₂>τ; if yes, then the anomaly is classified as a structural attack in step 444. Also, step 445 includes determining if |ΔD|₂>τ; if yes, then the anomaly is classified as a dynamic attack in step 446. Also, anomalies affecting both S and D may be classified in step 447 as a complex and/or multi-faceted attack. In one or more embodiments, when there exists both at least one structural attack and at least one dynamic attack, wherein both S and D values are greater than threshold t, then such a situation is classified as a multi-faceted attack. Further, the detection process ends in step 448.

For each detected anomaly, at least one embodiment includes recording, as output, the type of attack (e.g., structural or dynamic), the severity based at least in part on deviation score, and the affected node(s) and/or edge(s).

By way merely of illustration, assume the following continuation of the above IOT network example. In such an example, also assume baseline values of S_{baseline}=[0.78, 0.72, 0.85] and S_{baseline}=[0.10, 0.18, 0.22], deviation computations of ΔS=[0.02, 0.03, 0.05] and ΔD=[0.05, 0.02, 0.03], and deviation scores of |ΔS|2=0.061 and |ΔD|2=0.061. In such an example embodiment, an output can be generated which identifies an anomaly detected in S and D with a deviation score of 0.061 is >τ (0.05), and is classified as a multi-faceted attack.

As also detailed herein, one or more embodiments include performing cross-latent simulation for proactive defense. In such an embodiment, cross-latent simulation is used to generate one or more synthetic adversarial scenarios, which facilitates evaluation of system vulnerabilities and refinement of defenses in real time. A cross-latent simulation process can include steps of perturbation of latent spaces, reconstruction of at least one simulated graph, defense evaluation, and insight(s) generation.

Perturbation of latent spaces can include implementing one or more controlled perturbations to the latent spaces to simulate one or more adversarial scenarios, for example, in accordance with Equation (5) and Equation (6) as follows:

Sₛᵢₘ=S+α·ΔS (5)

Dₛᵢₘ=D+β·ΔD (6)

wherein α and β represent scaling factors controlling the severity of structural and dynamic perturbations, respectively, and Sₛᵢₘ and Dₛᵢₘ represent the simulated perturbed latent spaces.

Reconstruction of a simulated graph can include, for example, combining Sₛᵢₘ and Dₛᵢₘ to reconstruct a synthetic graph Gₛᵢₘ, represented in accordance with Equation (7) as follows:

Gₛᵢₘ=f_{decoder}(Sₛᵢₘ,Dₛᵢₘ) (7)

wherein f_{decoder} is a mapping function that reconstructs node and edge attributes from the perturbed latent spaces.

Additionally, defense evaluation can include testing the given system's defenses against Gₛᵢₘ by running the GNN and measuring its performance, for example, with respect to detection accuracy and resilience. Measuring detection accuracy (Accₛᵢₘ) can include evaluating how well the GNN detects one or more simulated anomalies, and measuring resilience can include measuring the impact of the one or more simulated attacks on one or more GNN predictions, wherein such a measure can be computed via Equation (8) as follows:

$${Res}_{s i m} = \frac{A c {c}_{s i m}}{A c {c}_{b a s e l i n e}} \qquad ( 8 )$$

wherein Acc_{baseline} represents the GNN accuracy under normal conditions.

Further, insight generation can include analyzing Gₛᵢₘ to identify one or more vulnerable nodes, edges, and/or patterns. Such analysis can provide one or more actionable insights for refining one or more system defenses related to identifying components with significant deviation from one or more baseline features and/or detecting patterns or subgraphs most affected by adversarial perturbations.

By way of illustration, assume further continuation of the above IOT network example. In the example, assume that α=0.5 and β=0.3, and the simulated latent spaces are Sₛᵢₘ=[0.81, 0.765, 0.915] and Dₛᵢₘ=[0.165, 0.206, 0.259]. Additionally, in this example, a synthetic graph is reconstructed and resilience is evaluated as follows: Resₛᵢₘ=0.850.90≈0.944.

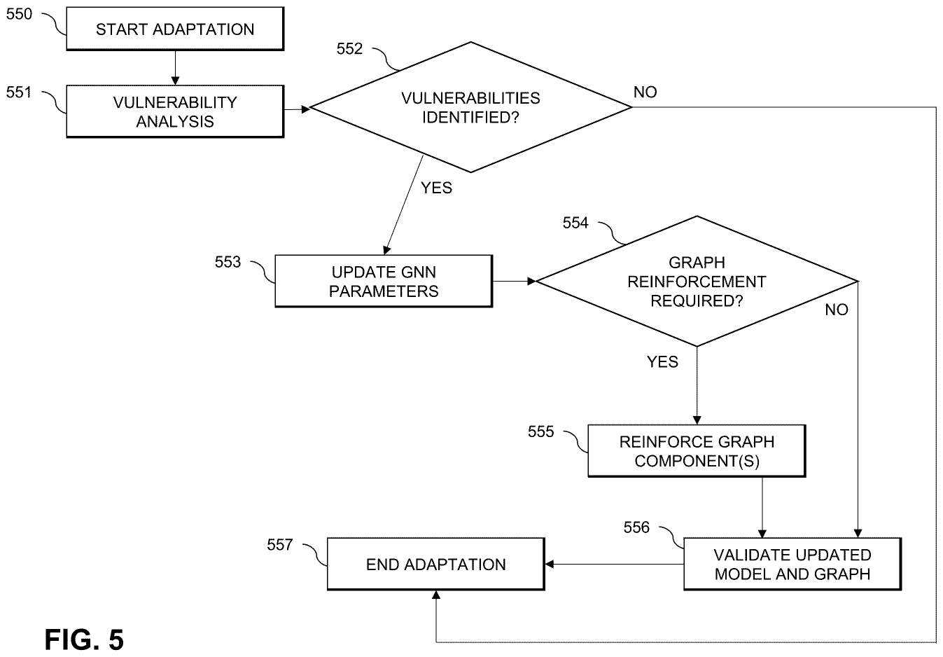

FIG. 5 shows an example defense mechanism adaptation workflow in an illustrative embodiment. By way of illustration, FIG. 5 depicts implementing a defense mechanism adaptation, which includes refining one or more GNN defenses based at least in part on insights gained from one or more adversarial simulations. Also, a defense mechanism adaptation can ensure that the system in question adapts to one or more evolving threats by updating one or more parameters and fortifying one or more vulnerable graph components. Referring again to FIG. 5, a defense mechanism adaptation process can start in step 550, and continue to vulnerability analysis in step 551, parameter updating in step 553, reinforcing graph components in step 555, and validating the updated model and graph in step 557.

More particularly, a vulnerability analysis in step 551 can include identifying one or more weak nodes and/or edges in Gₛᵢₘ based at least in part on their susceptibility to one or more adversarial attacks, and computing a vulnerability score for each component (e.g., each node) using Equation (9) as follows:

$$Vulnerability Score = \frac{Impact of Perturbation}{Baseline Feature Value} \qquad ( 9 )$$

For example, a significant drop in signal strength or node activity can indicate high vulnerability. Also, the higher the vulnerability score, the higher the impact of the perturbation(s).

Accordingly, step 552 includes determining if a vulnerability is identified. If no, then the adaptation process ends at step 557. If yes, then step 553 includes performing parameter updates to adjust one or more GNN parameters (e.g., θ) to enhance GNN resilience against the one or more detected vulnerabilities. In performing parameter updates, at least one example embodiment can include using gradient-based optimization, in accordance with Equation (10) as follows:

θ_{new}=θ_{old}−η·∇_{θ} [symbol] (Gₛᵢₘ,Target Defense) (10)

wherein η represents a learning rate, and [symbol] represents the loss function designed to minimize the effect of simulated adversarial scenarios.

Also, step 554 includes determining if graph reinforcements are required in connection with the parameter updates. For example, if there are changes in the update in GNN parameters, then there should be one or more graph reinforcement and/or one or more updates to the graph components. If no, then the updated model is validated in step 556. If yes, then step 555 includes performing graph reinforcement, which can include strengthening one or more vulnerable components in Gₛᵢₘ, for example, by adding redundancy to one or more critical edges, increasing the weight of one or more critical edges, adjusting one or more features of one or more vulnerable nodes to mitigate potential disruptions, etc.

Further, validating the updated model and graph in step 556 can include testing the updated GNN and reinforced graph using the original and simulated scenarios. Based at least in part on such testing, at one or more embodiments can include measuring the improvement in one or more metrics such as detection accuracy, resilience score, etc. Further, as illustrated in FIG. 5, the adaptation process ends in step 557.

By way merely of illustration, and continuing with the IOT network example above, assume that the Gₛᵢₘ includes Node-1, which includes a reading of 25.0 degrees Celsius, and Node-2, which includes a signal strength of −80 dBm (perturbed). Also, a vulnerability analysis indicates that Edge (1, 2) has a vulnerability score of (−80−(−67))/−67≈0.19 (indicating high vulnerability). Accordingly, in such an example, a parameter update is carried out to optimize one or more GNN parameters to reduce the effect of Gₛᵢₘ on model predictions. Graph reinforcement is carried out by increasing the weight of edge (1, 2) and/or adding a backup link to edge (1, 2) to ensure connectivity. Further, in such an example, validation results can include a detection accuracy of 92% and a resilience score of 0.88.

As such, in such an example, one or more embodiments can include generating an output which includes a final graph, G_{secure}, incorporating the reinforced components and updated node and/or edge attributes, wherein such a graph is free from adversarial influences. The output can also include a report summarizing the detected anomalies and simulated adversarial scenarios, the actions taken (e.g., parameter updates, graph reinforcements, etc.), and the final detection accuracy, resilience score(s) and improvement ratio for the GNN.

As detailed herein, one or more embodiments include implementing a latent space decoupling mechanism that separates graph representations into at least one structural latent portion, which captures one or more global graph properties (e.g., topology and connectivity), and at least one dynamic latent portion, which encodes one or more localized temporal changes and/or fine-grained interactions. This separation addresses interpretability and precision issues by enabling targeted anomaly detection in each latent space. Unlike conventional approaches, such an embodiment includes facilitating precise anomaly localization, enabling the identification of specific structural or dynamic attack vectors, improved adaptability to dynamic graphs, as changes in topology and interactions are independently analyzed, and enhanced robustness to adversarial perturbations.

Additionally, at least one embodiment includes implementing a cross-latent simulation mechanism that generates synthetic adversarial scenarios by discomposing the decoupled latent spaces. More particularly, in such an embodiment, one or more structural perturbations are simulated by modifying S (e.g., introducing and/or removing edges), and one or more dynamic perturbations are simulated by manipulating D (e.g., altering one or more node attributes and/or temporal interactions). The simulated adversarial graphs can then be used to evaluate and refine system defenses in real time. Accordingly, such an embodiment includes enabling proactive evaluation of one or more vulnerabilities by creating adversarial scenarios that go beyond pre-defined attack patterns. Also, the separation of structural and dynamic perturbations ensures that defenses can be tailored to specific threat types, and one or more embodiments can include relatedly generating and providing actionable insights for reinforcing one or more vulnerable graph components, improving the given system's adaptability to new threats.

FIG. 6 is a flow diagram of a process for enhancing system-related GNNs in an illustrative embodiment. It is to be understood that this particular process is only an example, and additional or alternative processes can be carried out in other embodiments.

In this embodiment, the process includes steps 600 through 608. These steps are assumed to be performed by the automated GNN enhancement system 105 utilizing elements 112, 114, 116 and 118.

Step 600 includes decoupling, using at least one graph neural network model, a latent space of at least one input graph structure into at least a first latent space related to topology and one or more relationships in the at least one input graph structure, and at least a second latent space related to one or more localized changes in the at least one input graph structure. In at least one embodiment, decoupling the latent space of at least one input graph includes processing the at least one input graph using the at least one graph neural network model processes to generate a combined latent space of the at least one input graph, and performing latent space decoupling on the combined latent space of the at least one input graph. Additionally or alternatively, decoupling the latent space of at least one input graph can include decoupling the at least a first latent space using one or more global pooling techniques to aggregate features across the at least one input graph, and decoupling the at least a second latent space using one or more attention mechanisms to identify one or more interactions of a designated granularity within the at least one input graph.

Step 602 includes generating at least one synthetic version of the at least one input graph structure by implementing one or more designated perturbations to the at least a first latent space and implementing one or more designated perturbations to the at least a second latent space. In one or more embodiments, generating at least one synthetic version of the at least one input graph structure includes simulating one or more adversarial activities in connection with the at least one input graph structure.

Step 604 includes detecting one or more anomalies associated with the at least one synthetic version of the at least one input graph structure based at least in part on computing one or more latent space deviations between the at least one input graph structure and the at least one synthetic version. In at least one embodiment, detecting one or more anomalies includes measuring one or more magnitude values associated with the one or more latent space deviations using at least one distance metric.

Step 606 includes performing a determination that the one or more anomalies are caused by at least one of the one or more designated perturbations to the at least a first latent space and the one or more designated perturbations to the at least a second latent space. In one or more embodiments, performing a determination includes determining, across the at least a first latent space and the at least a second latent space, susceptibility of graph structure components to one or more adversarial attacks based at least in part on impact of the one or more designated perturbations relative to one or more baseline values.

Step 608 includes performing one or more automated actions, based at least in part on the performing of the determination, in connection with modifying at least one of the at least one input graph structure and the at least one graph neural network model. In at least one embodiment, performing one or more automated actions includes reinforcing one or more vulnerable components of the at least one input graph structure, identified in connection with performing the determination. In such an embodiment, reinforcing one or more vulnerable components of the at least one input graph structure can include one or more of adding redundancy to one or more edges within the at least one input graph structure, increasing a weight of one or more edges within the at least one input graph structure, adjusting one or more features of one or more nodes within the at least one input graph structure. Additionally or alternatively, performing one or more automated actions can include adjusting one or more parameters of the at least one graph neural network model to reduce an effect of the at least one synthetic version of the at least one input graph structure on one or more model predictions.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to modify GNNs and/or corresponding graph structures in connection with decoupling latent spaces of the graph structures and detecting anomalies therein. These and other embodiments can effectively overcome problems associated with misclassification of information arising from adversarial attacks related to modifications to graph data.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

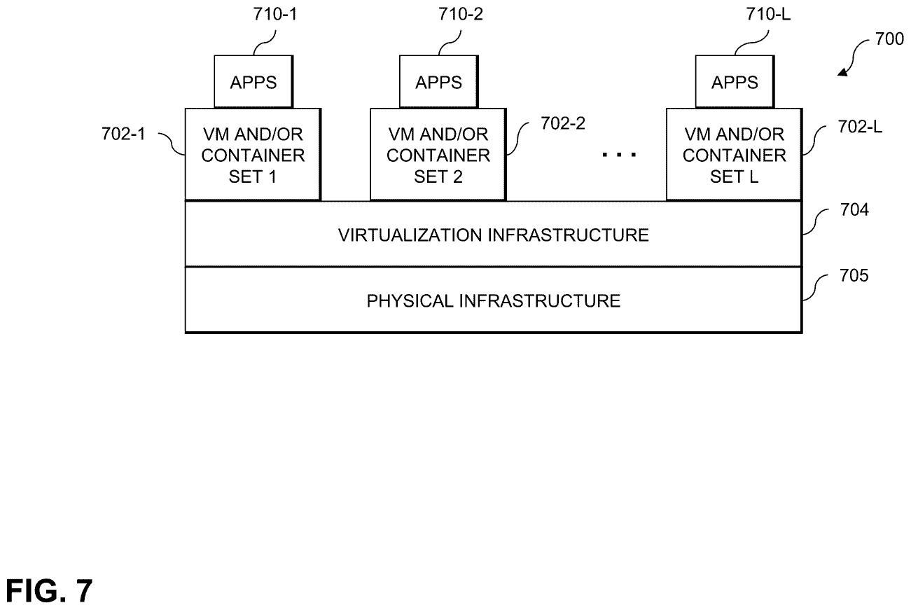

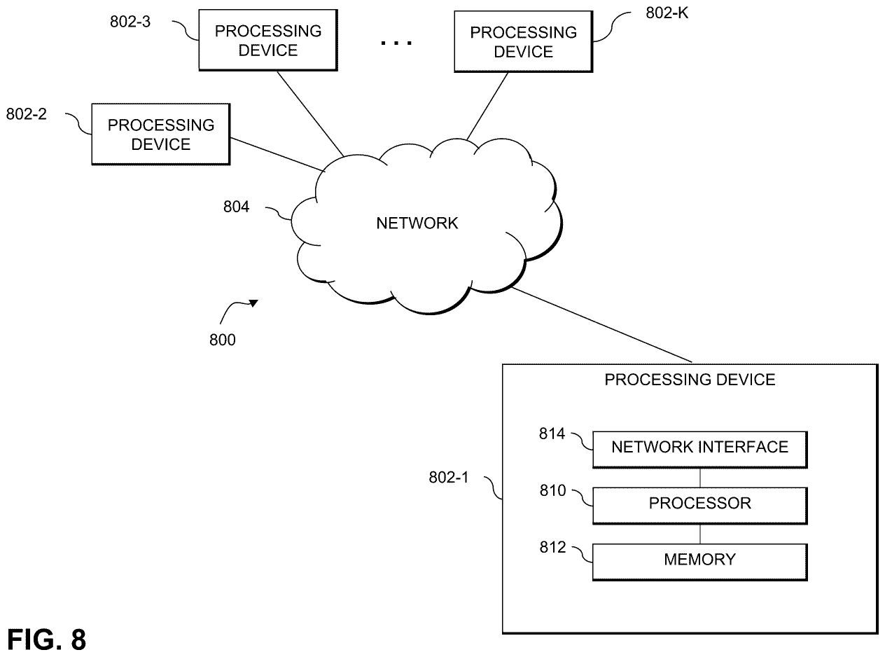

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more information processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory 812 comprises RAM, ROM or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
decoupling, using at least one graph neural network model, a latent space of at least one input graph structure into at least a first latent space related to topology and one or more relationships in the at least one input graph structure, and at least a second latent space related to one or more localized changes in the at least one input graph structure;
generating at least one synthetic version of the at least one input graph structure by implementing one or more designated perturbations to the at least a first latent space and implementing one or more designated perturbations to the at least a second latent space;
detecting one or more anomalies associated with the at least one synthetic version of the at least one input graph structure based at least in part on computing one or more latent space deviations between the at least one input graph structure and the at least one synthetic version;
performing a determination that the one or more anomalies are caused by at least one of the one or more designated perturbations to the at least a first latent space and the one or more designated perturbations to the at least a second latent space; and
performing one or more automated actions, based at least in part on the performing of the determination, in connection with modifying at least one of the at least one input graph structure and the at least one graph neural network model;
wherein the method is performed by at least one processing device comprising a processor coupled to a memory.

2. The computer-implemented method of claim 1, wherein decoupling the latent space of at least one input graph comprises processing the at least one input graph using the at least one graph neural network model processes to generate a combined latent space of the at least one input graph, and performing latent space decoupling on the combined latent space of the at least one input graph.

3. The computer-implemented method of claim 1, wherein generating at least one synthetic version of the at least one input graph structure comprises simulating one or more adversarial activities in connection with the at least one input graph structure.

4. The computer-implemented method of claim 1, wherein performing one or more automated actions comprises reinforcing one or more vulnerable components of the at least one input graph structure, identified in connection with performing the determination.

5. The computer-implemented method of claim 4, wherein reinforcing one or more vulnerable components of the at least one input graph structure comprises one or more of adding redundancy to one or more edges within the at least one input graph structure, increasing a weight of one or more edges within the at least one input graph structure, adjusting one or more features of one or more nodes within the at least one input graph structure.

6. The computer-implemented method of claim 1, wherein performing one or more automated actions comprises adjusting one or more parameters of the at least one graph neural network model to reduce an effect of the at least one synthetic version of the at least one input graph structure on one or more model predictions.

7. The computer-implemented method of claim 1, wherein decoupling the latent space of at least one input graph comprises decoupling the at least a first latent space using one or more global pooling techniques to aggregate features across the at least one input graph.

8. The computer-implemented method of claim 1, wherein decoupling the latent space of at least one input graph comprises decoupling the at least a second latent space using one or more attention mechanisms to identify one or more interactions of a designated granularity within the at least one input graph.

9. The computer-implemented method of claim 1, wherein detecting one or more anomalies comprises measuring one or more magnitude values associated with the one or more latent space deviations using at least one distance metric.

10. The computer-implemented method of claim 1, wherein performing a determination comprises determining, across the at least a first latent space and the at least a second latent space, susceptibility of graph structure components to one or more adversarial attacks based at least in part on impact of the one or more designated perturbations relative to one or more baseline values.

11. A non-transitory processor-readable storage medium having stored therein program code of one or more software programs, wherein the program code when executed by at least one processing device causes the at least one processing device:
to decouple, using at least one graph neural network model, a latent space of at least one input graph structure into at least a first latent space related to topology and one or more relationships in the at least one input graph structure, and at least a second latent space related to one or more localized changes in the at least one input graph structure;
to generate at least one synthetic version of the at least one input graph structure by implementing one or more designated perturbations to the at least a first latent space and implementing one or more designated perturbations to the at least a second latent space;
to detect one or more anomalies associated with the at least one synthetic version of the at least one input graph structure based at least in part on computing one or more latent space deviations between the at least one input graph structure and the at least one synthetic version;
to perform a determination that the one or more anomalies are caused by at least one of the one or more designated perturbations to the at least a first latent space and the one or more designated perturbations to the at least a second latent space; and
to perform one or more automated actions, based at least in part on the performing of the determination, in connection with modifying at least one of the at least one input graph structure and the at least one graph neural network model.

12. The non-transitory processor-readable storage medium of claim 11, wherein decoupling the latent space of at least one input graph comprises processing the at least one input graph using the at least one graph neural network model processes to generate a combined latent space of the at least one input graph, and performing latent space decoupling on the combined latent space of the at least one input graph.

13. The non-transitory processor-readable storage medium of claim 11, wherein generating at least one synthetic version of the at least one input graph structure comprises simulating one or more adversarial activities in connection with the at least one input graph structure.

14. The non-transitory processor-readable storage medium of claim 11, wherein
performing one or more automated actions comprises reinforcing one or more vulnerable components of the at least one input graph structure, identified in connection with performing the determination.

15. The non-transitory processor-readable storage medium of claim 11, wherein performing one or more automated actions comprises adjusting one or more parameters of the at least one graph neural network model to reduce an effect of the at least one synthetic version of the at least one input graph structure on one or more model predictions.

16. An apparatus comprising:
at least one processing device comprising a processor coupled to a memory;
the at least one processing device being configured:
to decouple, using at least one graph neural network model, a latent space of at least one input graph structure into at least a first latent space related to topology and one or more relationships in the at least one input graph structure, and at least a second latent space related to one or more localized changes in the at least one input graph structure;
to generate at least one synthetic version of the at least one input graph structure by implementing one or more designated perturbations to the at least a first latent space and implementing one or more designated perturbations to the at least a second latent space;
to detect one or more anomalies associated with the at least one synthetic version of the at least one input graph structure based at least in part on computing one or more latent space deviations between the at least one input graph structure and the at least one synthetic version;
to perform a determination that the one or more anomalies are caused by at least one of the one or more designated perturbations to the at least a first latent space and the one or more designated perturbations to the at least a second latent space; and
to perform one or more automated actions, based at least in part on the performing of the determination, in connection with modifying at least one of the at least one input graph structure and the at least one graph neural network model.

17. The apparatus of claim 16, wherein decoupling the latent space of at least one input graph comprises processing the at least one input graph using the at least one graph neural network model processes to generate a combined latent space of the at least one input graph, and performing latent space decoupling on the combined latent space of the at least one input graph.

18. The apparatus of claim 16, wherein generating at least one synthetic version of the at least one input graph structure comprises simulating one or more adversarial activities in connection with the at least one input graph structure.

19. The apparatus of claim 16, wherein performing one or more automated actions comprises reinforcing one or more vulnerable components of the at least one input graph structure, identified in connection with performing the determination.

20. The apparatus of claim 16, wherein performing one or more automated actions comprises adjusting one or more parameters of the at least one graph neural network model to reduce an effect of the at least one synthetic version of the at least one input graph structure on one or more model predictions.
